(19) United States
(12) Patent Application Publication
(10) Pub. No.: US 2018/0252917 A1
(43) Pub. Date: Sep. 6, 2018

(54) Display Image Projection Apparatus and Display Image Projection System

(71) Applicant: Yazaki Corporation, Tokyo (JP)

(72) Inventors: Nobuyuki Takahashi, Susono-shi (JP); Noriaki Narushima, Susono-shi (JP)

(73) Assignee: Yazaki Corporation, Tokyo (JP)

(21) Appl. No.: 15/911,425

(22) Filed: Mar. 5, 2018

(30) Foreign Application Priority Data
Mar. 6, 2017 (JP) 2017-041694

(51) Int. Cl. G02B 27/01; G03B 21/28

(52) U.S. Cl. CPC G02B 27/0101; B60K 2350/2052; G02B 2027/011; G03B 21/28

(57) ABSTRACT

A free-curved surface Fresnel mirror is disposed inside an HUD unit, and the display light from a display device is emitted to the image projection area of the windshield of a vehicle. A distortion correction function for suppressing aberrations is provided by using the free-curved surface formed by a free-curved surface Fresnel mirror having a planar shape. A half mirror with a magnifying function configured as a Fresnel mirror is disposed in the image projection area, whereby the half mirror with the magnifying function is provided with a magnifying function.

### CROSS REFERENCE TO RELATED APPLICATIONS

This application is based on and claims priority from Japanese patent application No. 2017-041694 filed on Mar. 6, 2017, the entire contents of which are incorporated herein by reference.

### BACKGROUND OF THE INVENTION

### 1. Technical Field

The present invention relates to a display image projection apparatus and a display image projection system capable of being mounted, for example, on a vehicle.

### 2. Background Art

For example, in the head-up display (HUD) apparatus disclosed in Patent Literature JP-A-2004-226469, the display light emitted from an optical unit is projected to a predetermined display area on the surface of the front windshield on the inside of the compartment of a vehicle, part of the display light is reflected and guided to the eye point of the driver. Hence, the image generated by the display light is formed as a virtual image ahead of the front windshield, and the virtual image can be visually recognized by the driver. The optical unit is composed of a display device built in the housing thereof, a first reflecting mirror and a second reflecting mirror.

Furthermore, in Patent Literature JP-A-2004-226469, the curvatures of the reflecting surfaces and the positional relationships of the plurality of reflecting mirrors provided in the optical system are specially devised to suppress image distortion occurring in the case that a display image is magnified.

### SUMMARY

However, in the case that an image is displayed by an HUD, aberrations occur, for example, under the influence due to the characteristics of the optical system of the HUD and due to the curved-surface shape of the windshield of a vehicle that is included in the optical path of the optical system. Hence, the aberrations are required to be corrected to obtain a clear display image, whereby such a technology as disclosed in Patent Literature JP-A-2004-226469 is required. Furthermore, generally speaking, aberrations can be corrected by adopting a non-spherical lens or a non-spherical mirror having a free-curved surface as a component of the optical system.

On the other hand, in vehicles in recent years, the necessity for displaying a virtual image at a longer distance position from the viewpoint of the driver and the necessity for making the display screen for displaying a virtual image larger are intensified in the HUD. Hence, it is necessary to raise the magnification factor of an image by increasing the curvatures of the lenses and mirrors disposed in the optical system of the HUD, and it is also necessary to dispose a plurality of optical systems so as to be arranged in sequence.

However, in order that a non-spherical mirror having a large curvature, for example, is accommodated in the housing of the HUD unit as a component, the housing itself is required to be made larger because the thickness dimension of the non-spherical mirror is large. It is thus difficult to install the HUD unit in a small space inside the vehicle.

The present invention has been made in consideration of the above-mentioned circumferences, and the object of the present invention is to provide a display image projection apparatus and a display image projection system capable of avoiding the enlargement of the housing even in the case that the virtual image display position is disposed at a long distance or the virtual image display screen is made larger.

To attain the above-mentioned object, a display image projection apparatus and a display image projection system according to the present invention is characterized as described in the following items (1) to (5).

(1) A display image projection apparatus having a housing, a display device accommodated in the housing, and a projection optical system accommodated in the housing and used to emit the display image of the display device in a predetermined direction, wherein

the projection optical system is equipped with a Fresnel mirror, and

the surface shape of the Fresnel mirror is formed in a state in which a free-curved surface shape for correcting aberrations occurring in the optical paths from the display device to a predetermined eye point is divided into a plurality of areas.

(2) The display image projection apparatus as set forth in the above-mentioned item (1), wherein

the surface shape of the Fresnel mirror has an optically magnifying function for magnifying an image to be formed in the optical paths from the display device to the eye point.

(3) A display image projection system being equipped with:

the display image projection apparatus as set forth in the above-mentioned item (1) and

a second Fresnel mirror disposed on the windshield of a vehicle or in the vicinity thereof to reflect at least part of the optical image emitted from the projection optical system and to guide the part of the optical image to the eye point, wherein

the surface shape of the second Fresnel mirror has an optically magnifying function for magnifying an image to be formed in the optical paths from the display device to the eye point.

(4) The display image projection apparatus as set forth in the above-mentioned item (1), wherein

the surface of the Fresnel mirror has a shape in which a plurality of circular or elliptical contour lines is arranged with the almost central position thereof being used as a reference, and

a concave section having a constant depth and an inclined face are formed around one circumference between the contour lines adjacent to each other, and the angle of the inclined face changes depending on the difference in the position in the circumferential direction.

(5) The display image projection apparatus as set forth in the above-mentioned item (1), wherein

the surface of the Fresnel mirror has a shape in which a plurality of circular or elliptical contour lines is arranged with the almost central position thereof being used as a reference, and

a concave section and an inclined face having a constant angle are formed between the contour lines adjacent to each other, and the depth of the concave section changes continuously depending on the difference in the position in the circumferential direction,

With the display image projection apparatus configured as described in the above-mentioned item (1), since the aberrations occurring in the optical paths from the display device to the predetermined eye point can be corrected by the surface shape of the Fresnel mirror, a clear image can be formed. Furthermore, since the Fresnel mirror is not required to be made larger in thickness and in size even in the case that the virtual image display position is disposed at a long distance or the virtual image display screen is made larger, the display image projection apparatus can be accommodated in a compact housing and can be installed in a small space in the vehicle.

With the display image projection apparatus configured as described in the above-mentioned item (2), since the Fresnel mirror has an optically magnifying function, the virtual image display position can be disposed at a long distance and the virtual image display screen can be made larger without installing a special optical device for magnification on the outside of the apparatus.

With the display image projection apparatus configured as described in the above-mentioned item (3), since the second Fresnel mirror having a planar shape is used to reflect the optical image emitted from the projection optical system, the HUD can attain virtual image display without remarkably changing the surface shape of the windshield of the vehicle. Furthermore, since the second Fresnel mirror has an optically magnifying function, no optically magnifying function is required to be provided inside the display image projection apparatus (main body). Moreover, even in the case that an optically magnifying function is provided inside the display image projection apparatus (main body), the magnification factor thereof can be lowered. Hence, even in the case that the virtual image display position is disposed at a long distance or the virtual image display screen is made larger, the range (width) of the optical path through which the optical image emitted from the display image projection apparatus (main body) passes can be made smaller and the display image projection apparatus can be mounted on the vehicle easily.

With the display image projection apparatus configured as described in the above-mentioned item (4), since a free-curved shape required for correcting the aberrations can be formed on the surface of the Fresnel mirror, a distortion correction function can be provided for the Fresnel mirror having a planar shape.

With the display image projection apparatus configured as described in the above-mentioned item (5), since a free-curved shape required for correcting the aberrations can be formed on the surface of the Fresnel mirror, a distortion correction function can be provided for the Fresnel mirror having a planar shape.

The present invention has been described above briefly. Moreover, the details of the present invention will be further clarified by reading the descriptions of the modes (hereafter referred to as “embodiments”) for embodying the invention to be described below referring to the accompanying drawings.

### BRIEF DESCRIPTION OF THE DRAWINGS

FIG. 1 is an optical path diagram showing a configuration of a display image projection system and the optical paths thereof according to an embodiment of the present invention as viewed from the side of a vehicle;

FIG. 2 is a front view showing the internal structure of the HUD unit shown in FIG. 1 and the optical paths thereof;

FIG. 3A is a perspective view showing an example of an external appearance of a free-curved surface mirror, and FIG. 3B is a perspective view showing an example of an external appearance of a free-curved surface Fresnel mirror 13;

FIG. 4A is a schematic view showing the planar shape, the cross-sectional shape in the thickness direction and the curvature distribution of the free-curved surface mirror, FIG. 4B is a cross-sectional view showing the cross-sectional shape at the section A in FIG. 4A, and FIG. 4C is a cross-sectional view showing the cross-sectional shape at the section B in FIG. 4A;

FIG. 5 is a cross-sectional view showing a configuration of a half mirror with a magnifying function built inside the windshield of the vehicle;

FIG. 6 is an optical path diagram showing the difference in the optical path depending on the presence/absence of the magnifying function in the half mirror with the magnifying function on the windshield of the vehicle;

FIG. 7 is a cross-sectional view showing Modification (1) of the mounting structure of the half mirror with the magnifying function; and

FIG. 8 is a cross-sectional view showing Modification (2) of the mounting structure of the half mirror with the magnifying function.

### DETAILED DESCRIPTION OF EMBODIMENTS

Specific embodiments of a display image projection apparatus and a display image projection system according to the present invention will be described below referring to the accompanying drawings,

### First Embodiment

First, the outline of the configuration and operation will be described.

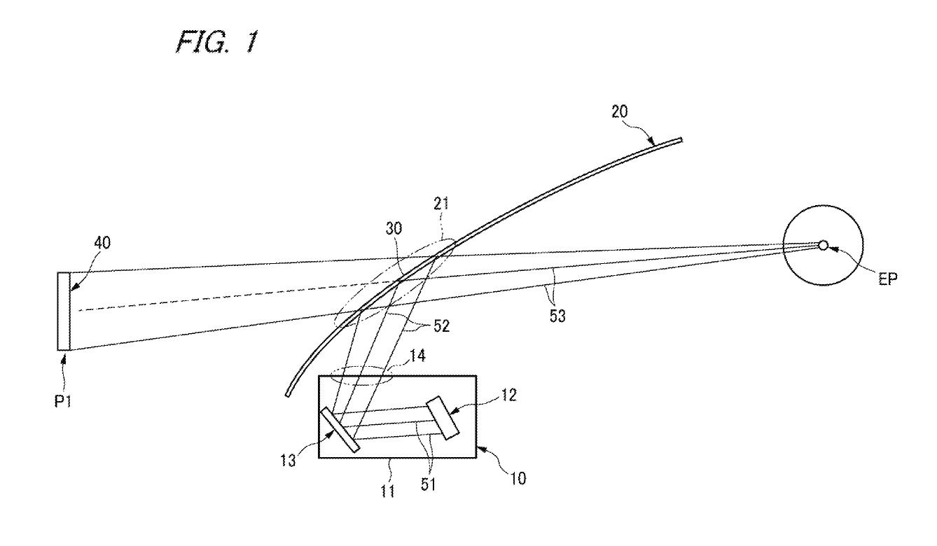

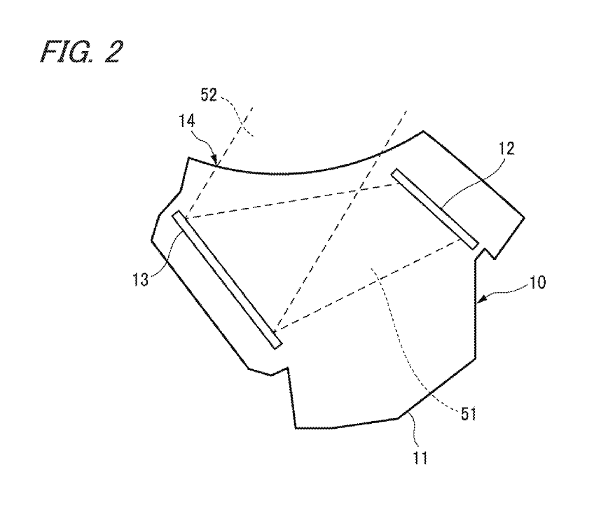

FIG. 1 shows the outline of a configuration of a display image projection system and the optical paths thereof according to an embodiment of the present invention as viewed from the side of a vehicle. Furthermore, FIG. 2 shows the internal structure of the HUD unit 10 shown in FIG. 1 and the optical paths thereof.

The display image projection system shown in FIG. 1 is intended to attain a head-up display (HUD) capable of being visually recognized by the driver on a vehicle. This display image projection system is equipped with an HUD unit 10 and a half mirror 30 with a magnifying function.

The HUD unit 10 is installed, for example, in a state of being fixed inside the dashboard ahead of the drivers seat of the vehicle. The display light emitted from the display light emitting section 14 of the HUD unit 10 passes through an optical path 52 via the opening of the dashboard and is guided to the image projection area 21 of the windshield (window glass) 20 of the vehicle provided upward.

In the example shown in FIG. 1, the half mirror 30 with the magnifying function is built in the image projection area 21 of the windshield 20. Part of the display light incident on the windshield 20 through the optical path 52 is reflected by the surface of the half mirror 30 with the magnifying function, passes through an optical path 53 and is directed to the eye point EP corresponding to the eye position of the driver.

Hence, in the case that the driver of the vehicle is looking toward the image projection area 21 of the windshield 20, the driver can visually recognize a virtual image 40 that is formed as if the image exists at a virtual image display position P1 ahead of the windshield 20. The visible information displayed as the virtual image 40 is the display image generated by the HUD unit 10 and is a visible image equivalent to the content displayed on the display screen of the display device 12 in the HUD unit 10.

Furthermore, since the half mirror 30 with the magnifying function transmits part of the light, when the driver is looking toward the image projection area 21, he can visually recognize, in addition to the virtual image 40, various scenes outside the vehicle in a state of being overlapped with the virtual image 40.

Since the half mirror 30 with the magnifying function in this embodiment has an optically magnifying function, the driver visually recognizes the virtual image 40 that is made larger than the optical image emitted from the HUD unit 10. Hence, the HUD display can be enlarged.

In the configuration shown in FIG. 2, the display device 12 and a free-curved surface Fresnel mirror 13 are provided inside the housing 11 of the HUD unit 10. The display device 12 is configured, for example, as a liquid crystal display panel or an organic EL display panel having a two-dimensional display screen. Moreover, the display device 12 is equipped with an illumination function as in the case of a backlight. For this reason, the display device 12 can emit an optical image including the two-dimensional visible information displayed on its display screen.

The optical image emitted from the display device 12 passes through the optical path 51 and is incident on the surface of the free-curved surface Fresnel mirror 13. The incident optical image is reflected by the surface of the free-curved surface Fresnel mirror 13 and is emitted from the display light emitting section 14 of the HUD unit 10.

A turning back mirror, not shown, may be disposed in the optical path between the display device 12 and the free-curved surface Fresnel mirror 13. The degree of freedom in the arrangement position of each of the display device 12 and the free-curved surface Fresnel mirror 13 is enhanced by providing this kind of turning back mirror.

### <Explanation of Aberrations>

In the display image projection system shown in FIG. 1, however, various aberrations may occur. Due to these aberrations, color bleeding, blurring, distortion, etc. occur in the visible image that is visually recognized as the virtual image 40 by the driver. In reality, it is supposed that aberrations, such as the aberration occurring at each section of the optical system inside the HUD unit 10 and the aberration caused, for example, by the curved-surface shape of the reflecting surface of the windshield 20, may occur. Hence, it is necessary to avoid the occurrence of the above-mentioned aberrations so that the driver can visually recognize clear display images.

In the HUD unit 10 shown in FIG. 2, the free-curved surface Fresnel mirror 13 is equipped with a distortion correction function for avoiding the occurrence of the above-mentioned aberrations. Since the free-curved surface Fresnel mirror 13 has a reflecting surface formed as a free-curved surface, the Fresnel mirror 13 can correct distortions causing various aberrations by applying an appropriate curvature to each area of the reflecting surface.

In the case of a general free-curved surface mirror, however, even in the case that the mirror is formed into a thin plate shape, the mirror is formed into a curved shape as a whole, whereby it is inevitable that the overall dimension in the thickness direction thereof becomes large. For this reason, the housing 11 is inevitably required to be enlarged to accommodate such a general free-curved surface mirror in the housing 11 of the HUD unit 10. In particular, in the case that the magnification factor thereof is high or in the case that the virtual image 40 is formed at a long distance, the bending of the free-curved surface mirror becomes large and the thickness dimension of the mirror also becomes large to attain a large curvature.

The free-curved surface Fresnel mirror 13 according to this embodiment is attained as a planar Fresnel mirror having a distortion correction function equivalent to that of the free-curved surface mirror. The details of the free-curved surface Fresnel mirror 13 are as described below.

### <Explanation of the External Appearance>

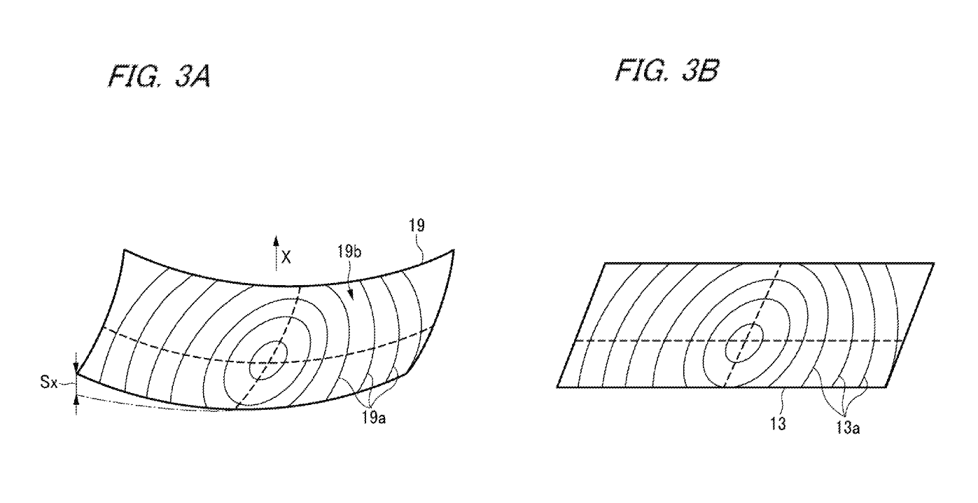

FIG. 3A shows an example of an external appearance of a free-curved surface mirror 19, and FIG. 3B shows an example of an external appearance of the free-curved surface Fresnel mirror 13.

In the free-curved surface mirror 19 shown in FIG. 3A, a reflecting surface 19b having a free-curved surface shape is formed by bending a thin plate-shaped mirror material so as to be curved in the thickness direction (in the X direction). Each of the contour lines 19a shown in FIG. 3A is a line obtained by connecting positions having an equal height in the thickness direction and is an imaginary line not visible in reality.

Since the reflecting surface 19b is curved, the respective contour lines 19a are formed such that a plurality of elliptical shapes is arranged coaxially as shown in FIG. 3A. In reality, a predetermined free-curved surface can be formed by adjusting the curvature of each minute area of the reflecting surface 19b. Furthermore, aberrations can be corrected by disposing the free-curved surface in the optical path of an optical system, such as the HUD unit 10.

However, even if the material of the free-curved surface mirror 19 has a thin plate shape, since the reflecting surface 19b is curved, the overall thickness dimension Sx of the free-curved surface mirror 19 becomes large as shown in FIG. 3A. In particular, in the case that the curvature of the free-curved surface mirror 19 becomes large, the dimension Sx also increases. In addition, in the case that the free-curved surface mirror 19 having this configuration is built in the HUD unit 10, the housing 11 is required to be made larger depending on the dimension Sx.

Hence, in this embodiment, the free-curved surface Fresnel mirror 13 shown in FIG. 3B, instead of the free-curved surface mirror 19, is built in the HUD unit 10 to correct the distortions of the virtual image 40. Since the free-curved surface Fresnel mirror 13 shown in FIG. 3B is not curved but is formed into a planar shape, the thickness dimension thereof is very small. For this reason, the free-curved surface Fresnel mirror 13 can be accommodated easily in the housing 11 being small in size.

As shown in FIG. 3B, contour lines 13a similar to those on the surface of the free-curved surface mirror 19 are also formed on the surface of the free-curved surface Fresnel mirror 13. The respective contour lines 13a on the free-curved surface Fresnel mirror 13 can be seen actually as the lines obtained by connecting the top sections or the bottom sections of the concave/convex shapes formed on the surface of the free-curved surface Fresnel mirror 13. Furthermore, since the free-curved surface Fresnel mirror 13 is not curved but is formed into a planar (flat plate) shape, the heights of the respective contour lines 13a are different from those of the contour lines 19a of the free-curved surface mirror 19.

In order that a free-curved surface functionally equivalent to that of the free-curved surface mirror 19 is formed on the surface of the free-curved surface mirror 19, the free-curved surface intended to be obtained is divided into a plurality of areas, and the curved surfaces of the plurality of divided areas are arranged on a plane, whereby a Fresnel mirror is configured.

### <Explanation of a Specific Structure>

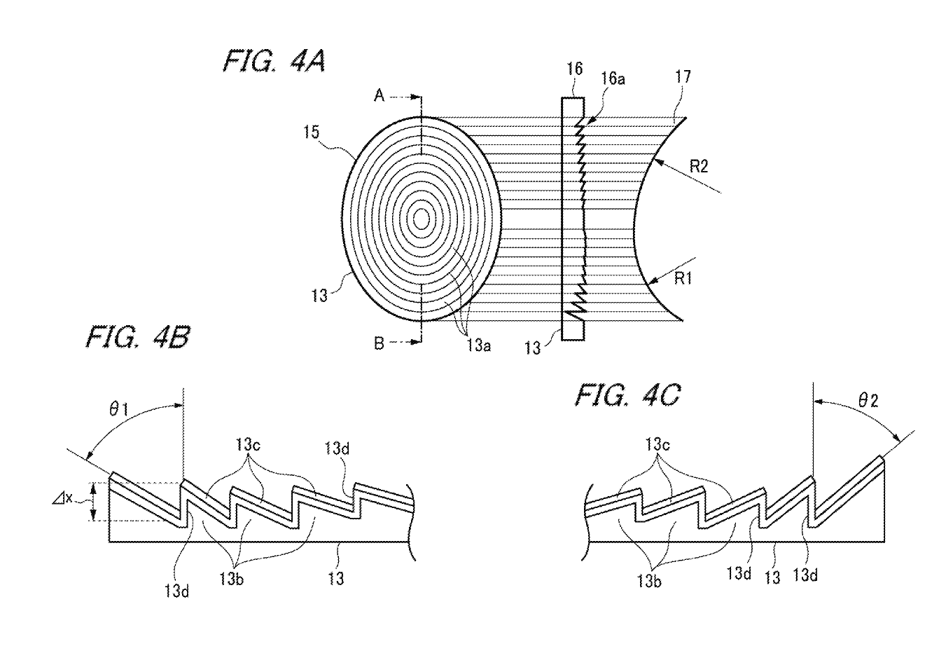

FIG. 4A schematically shows the planar shape 15, the cross-sectional shape 16 in the thickness direction and the curvature distribution 17 of the free-curved surface Fresnel mirror 13 so that these correspond to one another. Furthermore, FIG. 4B shows the cross-sectional shape at the section A in FIG. 4A, and FIG. 4C shows the cross-sectional shape at the section B in FIG. 4A.

As in the flat surface shape 15 shown in FIG. 4A, patterns resembling a plurality of coaxial circles or ellipses, similar to the contour lines 13a shown in FIG. 3B, appear on the surface (the Fresnel surface) of the free-curved surface Fresnel mirror 13. These patterns correspond to such sawtooth-shaped concave sections 16a as appearing in the cross-sectional shape 16 in the thickness direction shown in FIG. 4A.

In reality, as shown in FIGS. 4B and 4C, a minute prism section 13b is formed between the contour lines 13a being adjacent to each other. Furthermore, each prism section 13b has an inclined face 13c and a vertical wall 13d which extends in the thickness direction.

The shape and characteristics of each prism section 13b forming the free-curved surface can be specified by the inclination angle (θ1, θ2, etc.) of the inclined face 13c and the height (the depth of the concave section: the amount of sag Δx) of the vertical wall 13d.

In the free-curved surface Fresnel mirror 13 shown in FIGS. 4A, 4B and 40, the Fresnel surface is formed so as to conform to the conditions of “Specification 1” described below. “Specification 2” may be adopted instead of “Specification 1”.

### <“Specification 1” of the Fresnel Surface Shape>

(1) On the Fresnel surface, the height (Δx) of the vertical wall 13d is not uniform but changes for each area.

(2) Around one circumference in the circumferential direction of a single elliptical contour line 13a, the height (Δx) of the vertical wall 13d is constant.

(3) On the Fresnel surface, the inclination angle (θ1, θ2, etc.) of the inclined face 13c changes continuously depending on the difference in the position in the circumferential direction. For example, the inclination angle (θ1) of the outermost circumferential prism section 13b at the position shown in FIG. 4B is not the same as the inclination angle (θ2) at the position shown in FIG. 40.

### <“Specification 2” of the Fresnel Surface Shape>

(1) On the Fresnel surface, the height (Δx) of the vertical wall 13d is not uniform but changes for each area.

(2B) In each prism section 13b on the Fresnel surface, the height (Δx) of the vertical wall 13d changes continuously depending on the difference in the position in the circumferential direction,

(3B) In each prism section 13b on the Fresnel surface, the inclination angle of the inclined face 13c is constant around one circumference in the circumferential direction of a single elliptical contour line 13a.

In the case that the Fresnel surface is formed according to the conditions of the above-mentioned “Specification 1” or “Specification 2”, it is possible to configure the free-curved surface Fresnel mirror 13 having the Fresnel surface capable of performing a function optically equivalent to that of the free-curved surface. For example, the curvature and the curvature radius (R1, R2) changes depending on the position as in the curvature distribution shown in FIG. 4A. Hence, the free-curved surface Fresnel mirror 13 can be provided with the distortion correction function for suppressing the occurrence of the aberrations.

Next, the half mirror 30 with the magnifying function will be described in detail.

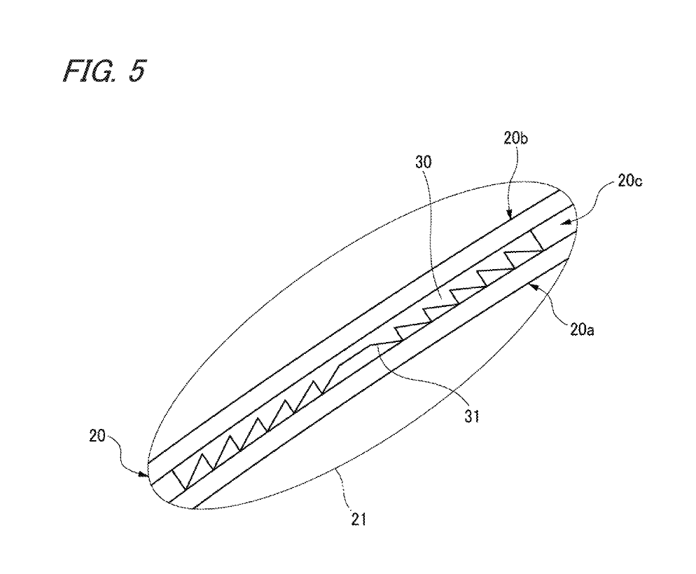

FIG. 5 shows a configuration example of the half mirror 30 with the magnifying function built inside the windshield of the vehicle.

The half mirror 30 with the magnifying function shown in FIG. 5 is configured as a Fresnel mirror similar in structure to the above-mentioned free-curved surface Fresnel mirror 13. However, also in the image projection area 21 of the windshield 20, the surface (the light reflecting surface 31) of the half mirror 30 with the magnifying function is configured as a half mirror so that the scenes outside the windshield 20 can be seen through the glass from the viewpoint of the driver.

In addition, although an example in the case that the Fresnel mirror of the half mirror 30 with the magnifying function has a function for optically magnifying a display image and does not have the distortion correction function is described in this embodiment, both the free-curved surface Fresnel mirror 13 and the half mirror 30 with the magnifying function may be provided with the distortion correction function. Furthermore, instead of a free-curved surface as in the free-curved surface Fresnel mirror 13, a Fresnel mirror having a general structure may be adopted for the Fresnel mirror of the half mirror 30 with the magnifying function. Moreover, transparent resin or glass is adopted as the main material constituting the half mirror 30 with the magnifying function so that the half mirror 30 functions as a half mirror.

In the example shown in FIG. 5, the windshield 20 of the vehicle is composed of two glass plates 20a and 20b and an intermediate film 20c being held therebetween. The half mirror 30 with the magnifying function is built inside the windshield 20 as part of the intermediate film 20c.

Since the half mirror 30 with the magnifying function is configured as a Fresnel mirror as described above, the half mirror 30 has a planar shape (flat plate shape) being thin in thickness and can be accommodated easily inside the windshield 20. Furthermore, the space between the light reflecting surface 31 of the half mirror 30 with the magnifying function and the glass plate 20a is filled with, for example, transparent resin having a refractive index equivalent to that of the glass plate 20a, thereby being sealed with the resin. This can prevent excessive reflection and refraction.

### <Influence Due to the Presence/Absence of the Magnifying Function on the Windshield 20>

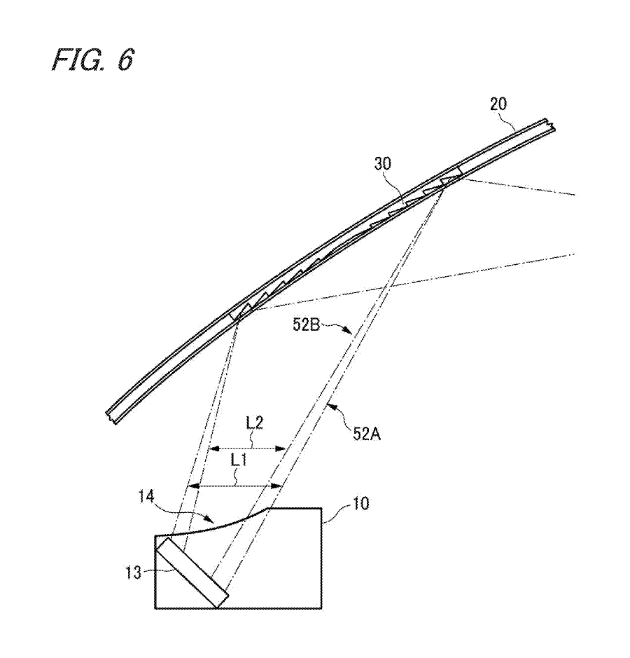

FIG. 6 shows the difference in the optical path depending on the presence/absence of the magnifying function in the half mirror 30 with the magnifying function on the windshield of the vehicle.

In the display image projection system shown in FIG. 1, under the condition that an image is formed as the virtual image 40 at the same position in the same size, such a difference as shown FIG. 6 is present between the optical path 52A in the case that the half mirror 30 has no magnifying function and the optical path 52B in the case that the half mirror 30 has the magnifying function. In other words, the relationship between the optical path width L1 of the optical path 52A and the optical path width L2 of the optical path 52B in the vicinity of the display light emitting section 14 of the HUD unit 10 becomes (L2<L1).

Hence, the opening of the dashboard corresponding to the display light emitting section 14, that is, the width of the opening, can be made smaller by providing the magnifying function of the half mirror 30 with the magnifying function on the windshield 20, whereby the housing 11 of the HUD unit 10 can be made more compact. Furthermore, since the effective areas required for the respective optical components inside the HUD unit 10 can be made smaller, the components can be made more compact and the housing 11 can also be made more compact.

<Modification (1) of the Half Mirror 30 with the Magnifying Function>

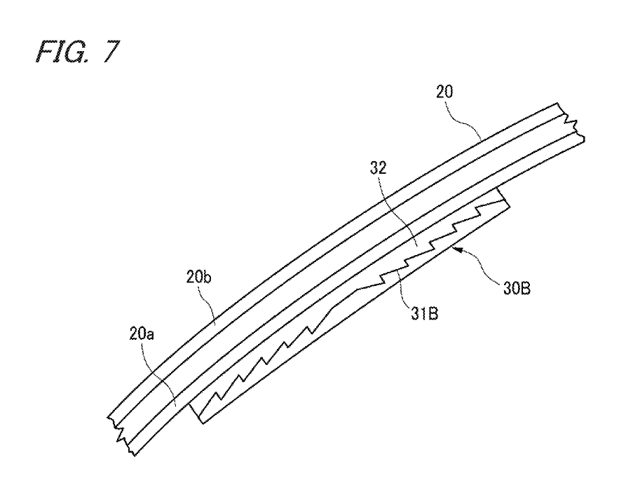

FIG. 7 shows Modification (1) of the mounting structure of the half mirror with the magnifying function.

The half mirror 30B with the magnifying function shown in FIG. 7 is different from the above-mentioned half mirror 30 with the magnifying function in the mounting structure on the windshield 20 although they are equivalent in shape and function.

More specifically, the half mirror 30B with the magnifying function shown in FIG. 7 is mounted in a state of being bonded to the surface of the glass plate 20a of the windshield 20 on the inside of the vehicle compartment. Furthermore, the half mirror 30B with the magnifying function is disposed in a state in which the Fresnel surface (reflecting surface 31B) thereof is opposed to the surface of the glass plate 20a. Moreover, the half mirror 30B with the magnifying function is bonded and fixed to the windshield 20 with the UV-hardened resin layer 32 formed between the Fresnel surface of the half mirror 30B and the glass plate 20a. The UV-hardened resin layer 32 is also filled in the concave sections in the Fresnel surface of the half mirror 30B with the magnifying function. Moreover, the UV-hardened resin layer 32 is made of a material having a refractive index equivalent to that of the glass plate 20a to prevent the occurrence of excessive refraction and reflection.

In the case that the mounting structure shown in FIG. 7 is adopted, after the manufacturing of the windshield 20, the half mirror 30B with the magnifying function can be bonded to the outside of the windshield as necessary, thereby being able to be mounted later.

<Modification (2) of the Half Mirror 30 with the Magnifying Function>

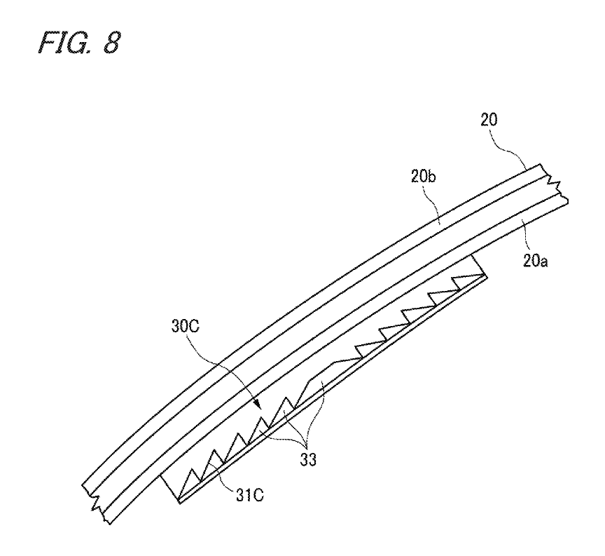

FIG. 8 shows Modification (2) of the mounting structure of the half mirror with the magnifying function.

The half mirror 30C with the magnifying function shown in FIG. 8 is different from the above-mentioned half mirror 30 with the magnifying function in the mounting structure on the windshield 20 although they are equivalent in shape and function.

More specifically, the half mirror 30C with the magnifying function shown in FIG. 8 is mounted in a state of being bonded to the surface of the glass plate 20a of the windshield 20 on the inside of the vehicle compartment. Furthermore, the half mirror 300 with the magnifying function is disposed in a state in which the surface (rear surface) thereof on the opposite side of the Fresnel surface (reflecting surface 31C) thereof is opposed to the surface of the glass plate 20a, and the rear face of the half mirror 300 with the magnifying function is bonded to the surface of the glass plate 20a by applying a transparent adhesive therebetween.

What's more, the surface of the half mirror 30C with the magnifying function including the concave sections of the Fresnel surface (reflecting surface 310) is filled with transparent sealing resin 33, thereby being formed into a planar shape. Consequently, the convex and concave sections on the Fresnel surface are not exposed to the outside, thereby being able to be protected.

In the case that the mounting structure shown in FIG. 8 is adopted, after the manufacturing of the windshield 20, the half mirror 300 with the magnifying function can be bonded to the outside of the windshield as necessary, thereby being able to be mounted later.

### Second Embodiment

In the above-mentioned display image projection system shown in FIG. 1, the free-curved surface Fresnel mirror 13 has the distortion correction function and the half mirror 30 with the magnifying function has the magnifying function. In a second embodiment, however, the free-curved surface Fresnel mirror 13 has a magnifying function in addition to the distortion correction function.

Hence, in the second embodiment, an image can be optically magnified by using both the free-curved surface Fresnel mirror 13 and the half mirror 30 with the magnifying function. The curvature distribution state of the Fresnel surface of the free-curved surface Fresnel mirror 13 in the second embodiment, not shown, is different from that in the first embodiment because the free-curved surface Fresnel mirror 13 is provided with the magnifying function. The function and the structure of the half mirror 30 with the magnifying function in the second embodiment are similar to those in the first embodiment.

Since both the free-curved surface Fresnel mirror 13 and the half mirror 30 with the magnifying function are provided with the magnifying function in the second embodiment, a large image can be formed as the virtual image 40 without making the curvatures of the Fresnel surfaces of the free-curved surface Fresnel mirror 13 and the half mirror 30 with the magnifying function so larger. Hence, even in the case that the HUD display screen is made larger, the free-curved surface Fresnel mirror 13 and the half mirror 30 with the magnifying function can be manufactured relatively easily.

Still further, since the half mirror 30 with the magnifying function has the magnifying function also in the second embodiment, the optical path width L2 of the optical path 52 of the optical image emitted from the HUD unit 10 is made smaller, whereby the HUD unit 10 can be made more compact.

### Third Embodiment

In the above-mentioned display image projection system shown in FIG. 1, the free-curved surface Fresnel mirror 13 has the distortion correction function and the half mirror 30 with the magnifying function has the magnifying function. In a third embodiment, however, each of the free-curved surface Fresnel mirror 13 and the half mirror 30 with the magnifying function has both the distortion correction function and the magnifying function.

Hence, in the third embodiment, an image can be optically magnified and distortion correction can be carried out by using both the free-curved surface Fresnel mirror 13 and the half mirror 30 with the magnifying function. The curvature distribution state of the Fresnel surface of the free-curved surface Fresnel mirror 13 in the third embodiment, not shown, is different from that in the first embodiment because the free-curved surface Fresnel mirror 13 is provided with the magnifying function.

Furthermore, since the above-mentioned half mirror 30 with the magnifying function is configured as a Fresnel mirror, a Fresnel surface having optically the same function as that of a free-curved surface can be formed as in the case of the above-mentioned free-curved surface Fresnel mirror 13 by devising the shape of the Fresnel surface. In addition, the half mirror 30 with the magnifying function can also be provided with the distortion correction function by using this free-curved surface.

As a specific example, a function for correcting only the causes of aberrations occurring inside the HUD unit 10 is provided as the distortion correction function of the free-curved surface Fresnel mirror 13. Furthermore, a function for correcting the aberrations occurring, for example, due to the curved-surface shape of the windshield 20 is provided as the distortion correction function of the half mirror 30 with the magnifying function.

The number of the types of the free-curved surface Fresnel mirror 13 can be avoided from increasing by assigning the distortion correction function for the entire system to both the free-curved surface Fresnel mirror 13 and the half mirror 30 with the magnifying function. For example, the free-curved surface Fresnel mirrors 13 having a common shape can be used for all the vehicle types by absorbing the change in the distortion correction function corresponding to the difference in vehicle type by the change in the free-curved shape of the half mirror 30 with the magnifying function.

With the display image projection apparatus and the display image projection system according to the present invention, even in the case that the virtual image display position is disposed at a long distance or the virtual image display screen is made larger, the housing of the HUD unit can be avoided from becoming larger. In other words, since the Fresnel mirror has a planar shape and is small in thickness, the Fresnel mirror can be accommodated in a compact housing even in the case that a large curvature is required for the correction of aberrations. Furthermore, the range (width) of the optical path through which the optical image emitted from the display image projection apparatus passes can be made smaller and the display image projection apparatus can be mounted on the vehicle easily by combining the display image projection apparatus with the second Fresnel mirror having an optically magnifying function.

The characteristics of the embodiments of the display image projection apparatus and the display image projection system according to the present invention described above will be briefly summarized and listed in the following items [1] to [5].

[1] A display image projection apparatus (an HUD unit 10) having a housing (11), a display device (12) accommodated in the housing, and a projection optical system accommodated in the housing and used to emit the display image of the display device in a predetermined direction, wherein

the projection optical system is equipped with a Fresnel mirror (a free-curved surface Fresnel mirror 13), and

the surface shape of the Fresnel mirror is formed in a state in which a free-curved surface shape for correcting aberrations occurring in the optical paths (51, 52, 53) from the display device to a predetermined eye point (EP) is divided into a plurality of areas (see FIG. 4A).

[2] The display image projection apparatus as set forth in the above-mentioned item [1], wherein

the surface shape of the Fresnel mirror (the free-curved surface Fresnel mirror 13) has an optically magnifying function for magnifying an image to be formed in the optical paths from the display device to the eye point.

[3] A display image projection system being equipped with:

the display image projection apparatus (the HUD unit 10) as set forth in the above-mentioned item [1] and

a second Fresnel mirror (a half mirror 30 with a magnifying function) disposed on the windshield (20) of a vehicle or in the vicinity thereof to reflect at least part of the optical image emitted from the projection optical system and to guide the part of the optical image to the eye point, wherein

the surface shape of the second Fresnel mirror has an optically magnifying function for magnifying an image to be formed in the optical paths from the display device to the eye point.

[4] The display image projection apparatus as set forth in the above-mentioned item [1], wherein

the surface of the Fresnel mirror (the free-curved surface Fresnel mirror 13) has a shape in which a plurality of circular or elliptical contour lines (13a) is arranged with the almost central position thereof being used as a reference (see FIGS. 3B and 4A), and

a concave section having a constant depth and an inclined face (13c) are formed around one circumference between the contour lines adjacent to each other, and the angle (81, 82) of the inclined face changes depending on the difference in the position in the circumferential direction (corresponding to the above-mentioned “Specification 1).

[5] The display image projection apparatus as set forth in the above-mentioned item [1], wherein

the surface of the Fresnel mirror (the free-curved surface Fresnel mirror 13) has a shape in which a plurality of circular or elliptical contour lines is arranged with the almost central position thereof being used as a reference, and

a concave section and an inclined face having a constant angle are formed between the contour lines adjacent to each other, and the depth of the concave section changes continuously depending on the difference in the position in the circumferential direction (corresponding to the above-mentioned “Specification 2).

What is claimed is:

1. A display image projection apparatus having a housing, a display device accommodated in the housing, and a projection optical system accommodated in the housing and used to emit the display image of the display device in a predetermined direction, wherein
the projection optical system is equipped with a Fresnel mirror, and
the surface shape of the Fresnel mirror is formed in a state in which a free-curved surface shape for correcting aberrations occurring in the optical paths from the display device to a predetermined eye point is divided into a plurality of areas.

2. The display image projection apparatus as set forth in claim 1, wherein
the surface shape of the Fresnel mirror has an optically magnifying function for magnifying an image to be formed in the optical paths from the display device to the eye point.

3. A display image projection system being equipped with:
the display image projection apparatus as set forth in claim 1 and
a second Fresnel mirror disposed on the windshield of a vehicle or in the vicinity thereof to reflect at least part of the optical image emitted from the projection optical system and to guide the part of the optical image to the eye point, wherein
the surface shape of the second Fresnel mirror has an optically magnifying function for magnifying an image to be formed in the optical paths from the display device to the eye point.

4. The display image projection apparatus as set forth in claim 1, wherein
the surface of the Fresnel mirror has a shape in which a plurality of circular or elliptical contour lines is arranged with the almost central position thereof being used as a reference, and
a concave section having a constant depth and an inclined face are formed around one circumference between the contour lines adjacent to each other, and the angle of the inclined face changes depending on the difference in the position in the circumferential direction.

5. The display image projection apparatus as set forth in claim 1, wherein
the surface of the Fresnel mirror has a shape in which a plurality of circular or elliptical contour lines is arranged with the almost central position thereof being used as a reference, and
a concave section and an inclined face having a constant angle are formed between the contour lines adjacent to each other, and the depth of the concave section changes continuously depending on the difference in the position in the circumferential direction.
